(19) United States
(12) Patent Application Publication
(10) Pub. No.: US 2025/0077137 A1
(43) Pub. Date: Mar. 6, 2025

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Yutaro SUGIBAYASHI, Kanagawa (JP)

(73) Assignee: FUJIFILM Business Innovation Corp., Tokyo (JP)

(21) Appl. No.: 18/595,693

(22) Filed: Mar. 5, 2024

(30) Foreign Application Priority Data
Aug. 28, 2023 (JP) 2023-137692

(51) Int. Cl. G06F 3/12

(52) U.S. Cl. CPC G06F 3/1222; G06F 3/1205; G06F 3/1238

(57) ABSTRACT

An information processing system includes a first information processing device that includes a first processor, and one or a plurality of network ports whose opening is restricted during operation in a security mode in which security is ensured, wherein when settings to be compatible with the security mode are configured for a second information processing device that includes a second processor and one or a plurality of network ports, the first processor and the second processor are configured to: cause, in response to a predetermined trigger, the first information processing device and the second information processing device to shift from the security mode to a setting mode in which only the network port used in configuring the settings for the second information processing device is opened for operation; duplicate the settings in the first information processing device to the second information processing device via the opened network port after the first information processing device and the second information processing device shift to the setting mode; and cause, in response to completion of duplication of the settings, the first information processing device and the second information device to return to the security mode from the setting mode.

### CROSS-REFERENCE TO RELATED APPLICATIONS

This application is based on and claims priority under 35 USC 119 from Japanese Patent Application No. 2023-137692 filed Aug. 28, 2023.

### BACKGROUND

### (i) Technical Field

The present disclosure relates to an information processing system and a non-transitory computer readable medium.

### (ii) Related Art

In recent years, in order to protect an in-house network constructed by using a LAN or the like from a security threat, companies are shifting from a perimeter defense model using a firewall to a zero trust defense model using neither a LAN nor a firewall. This is because it is becoming difficult to protect company assets with the perimeter defense model due to the recent diversification of work patterns including working from home, a shared office, or the like.

Solutions for achieving zero trust security that is based on the idea that nothing is trusted without authentication, that is, the idea of “zero trust” include secure access service edge (SASE), endpoint detection and response (EDR), and the like. “SASE” is a concept of a new security framework that integrates a security function and a network function in an IT environment into one cloud service. Further, “EDR” is an endpoint security solution that collects log data from endpoints connected to a network in an organization from a cloud, detects suspicious behaviors and cyber attacks by analyzing the log data, and notifies an administrator of the suspicious behaviors and cyber attacks.

In a zero trust network access (ZTNA) environment constructed based on the idea of zero trust, companies that use cloud services such as SASE and EDR tend to increase. Further, a technique has been proposed in which an attack from the outside is blocked by controlling opening and closing of a network port in a ZTNA environment in which a firewall is not used (for example, Japanese Unexamined Patent Application Publication No. 2022-132074 and Japanese Unexamined Patent Application Publication No. 2023-004323).

Incidentally, in an on-premise environment of a company, various devices connectable to a network, such as a personal computer (PC) and a multifunction peripheral equipped with a computer, are usually installed. Also, there are many cases where a multifunction peripheral is newly introduced. In such cases, in related art, there is a case in which necessary settings are simply configured for a new multifunction peripheral by transferring without change, so-called cloning, the settings in an existing multifunction peripheral to the new multifunction peripheral. In related art, the settings for a new information processing device are configured using an opened network port.

### SUMMARY

However, in a case where an information processing device is newly introduced into an information processing system operated in a security mode in which opening of a network port of an information processing device is restricted as a requirement for ensuring security, if the network port is unconditionally opened for configuring the settings for the information processing device to be newly introduced, there is a possibility that security is not ensured.

Aspects of non-limiting embodiments of the present disclosure relate to configuration of the settings to be compatible with a security mode while maintaining the state of ensuring security, for an information processing device to be newly introduced into an information processing system operated in a security mode in which opening of a network port of an information processing device is restricted as a requirement for ensuring security.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a first information processing device that includes a first processor, and one or a plurality of network ports whose opening is restricted during operation in a security mode in which security is ensured, in which when settings to be compatible with the security mode are configured for a second information processing device that includes a second processor and one or a plurality of network ports, the first processor and the second processor cause, in response to a predetermined trigger, the first information processing device and the second information processing device to shift from the security mode to a setting mode in which only the network port used in configuring the settings for the second information processing device is opened for operation, duplicate the settings in the first information processing device to the second information processing device via the opened network port after the first information processing device and the second information processing device shift to the setting mode, and cause, in response to completion of duplication of the settings, the first information processing device and the second information device to return to the security mode from the setting mode.

### BRIEF DESCRIPTION OF THE DRAWINGS

Exemplary embodiments of the present disclosure will be described in detail based on the following figures, wherein:

FIG. 1 is an overall configuration diagram illustrating an exemplary embodiment of an information processing system according to the present disclosure;

FIG. 2 is a block configuration diagram illustrating an information processing system according to a first exemplary embodiment;

FIG. 3A is a sequence diagram illustrating processing for configuring the settings for a not-set device to be compatible with a zero trust environment in the first exemplary embodiment;

FIG. 3B is a sequence diagram following FIG. 3A;

FIG. 4 is a diagram illustrating an example of screen display for confirming with a user whether to shift to an environment setting mode in the first exemplary embodiment;

FIG. 5 is a diagram illustrating an example of screen display for confirming with a user whether to shift to a zero trust mode in the first exemplary embodiment;

FIG. 6 is a block configuration diagram illustrating an information processing system according to a second exemplary embodiment;

FIG. 7A is a sequence diagram illustrating processing for configuring the settings for a not-set device to be compatible with the zero trust environment in the second exemplary embodiment;

FIG. 7B is a sequence diagram following FIG. 7A;

FIG. 8 is a diagram illustrating an example of screen display for confirming with a user whether to shift to an environment setting mode in the second exemplary embodiment;

FIG. 9 is a block configuration diagram illustrating an information processing system according to a third exemplary embodiment;

FIG. 10A is a sequence diagram illustrating processing for configuring the settings for a not-set device to be compatible with the zero trust environment in the third exemplary embodiment;

FIG. 10B is a sequence diagram following FIG. 10A;

FIG. 11 is a block configuration diagram illustrating an information processing system according to a fourth exemplary embodiment;

FIG. 12A is a sequence diagram illustrating processing for configuring the settings for a not-set device to be compatible with the zero trust environment in the fourth exemplary embodiment;

FIG. 12B is a sequence diagram following FIG. 12A; and

FIG. 13 is a diagram illustrating an example of screen display for confirming with a user whether to shift to an environment setting mode in the fourth exemplary embodiment.

### DETAILED DESCRIPTION

Hereinafter, preferred exemplary embodiments of the present disclosure will be described with reference to the drawings.

### First Exemplary Embodiment

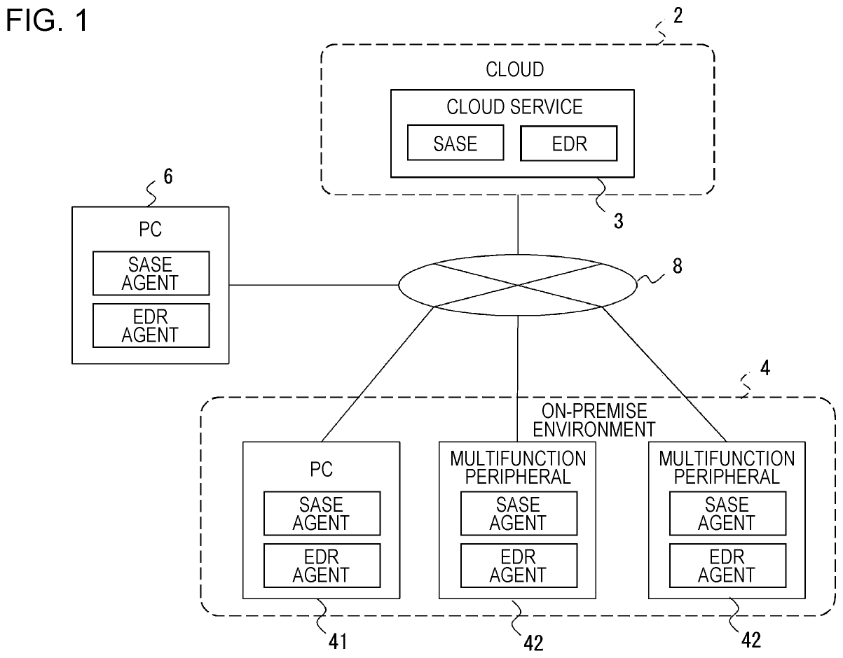

FIG. 1 is an overall configuration diagram illustrating an exemplary embodiment of an information processing system according to the present disclosure. FIG. 1 illustrates a configuration in which a cloud 2, an on-premise environment 4, and a PC 6 are connected via Internet 8. The cloud 2 provides companies or the like that aim to construct a ZTNA environment (hereinafter referred to as a “zero trust environment”) based on the idea that nothing is trusted without authentication, that is, the idea of “zero trust”, with a cloud service 3 such as SASE or EDR for supporting the construction of the zero trust environment.

The on-premise environment 4 is an in-house system environment of a company. In the on-premise environment 4, a PC 41 individually used by an employee or the like (hereinafter referred to as a “user”) and a multifunction peripheral 42 shared by users are installed. Note that, although one PC 41 and two multifunction peripherals 42 are illustrated in FIG. 1, the number of multifunction peripherals to be installed is not limited to this example and may be one or more. As illustrated in FIG. 1, a firewall is not installed in the on-premise environment 4 according to the present exemplary embodiment in order to adapt to the zero trust environment. Further, to the extent possible, a LAN is not permanently installed. Each information processing device such as the PC 41 and the multifunction peripheral 42 is individually connected to the Internet 8. For example, a mobile data communication technology may be used for connection to the Internet 8. Each information processing device is adapted to the zero trust environment by being installed with an SASE agent or an EDR agent for using the cloud service 3 such as SASE or EDR.

It is assumed that the PC 6 is used by a user of the company outside the on-premise environment 4 such as, for example, at the user's home or in a shared office. The PC 6 may be the PC 41 that has been taken out from the on-premise environment 4. Since it is assumed that the PC 6 operates under the zero trust environment, an SASE agent or an EDR agent is installed as in the PC 41 and the like.

The PCs 6 and 41 are illustrated as examples of information processing devices. The PC 41 may be implemented by a conventionally existing general-purpose hardware configuration. That is, the PC 41 includes storage means such as a ROM, a RAM, and an HDD, user interfaces such as a mouse, a keyboard, and a touch panel, a network interface for performing data communication via the Internet 8, wireless communication means for performing short-range communication by WiFi (registered trademark), BLE, or the like with another PC 41 or the multifunction peripheral 42 existing in the same on-premise environment 4, and the like.

The multifunction peripheral 42 is one form of an image forming device having various functions such as a printing function, a copying function, and a scanner function, and having a built-in computer. The multifunction peripheral 42 according to the present exemplary embodiment may be implemented by a conventionally existing general-purpose hardware configuration. That is, the multifunction peripheral 42 includes storage means such as a ROM, a RAM, and an HDD, a user interface such as an operation panel, a scanner and a printer that implement the various functions described above, a network interface for performing data communication via the Internet 8, wireless communication means for performing short-range communication by WiFi, BLE, or the like with the PC 41 or another multifunction peripheral 42 existing in the same on-premise environment 4, and the like.

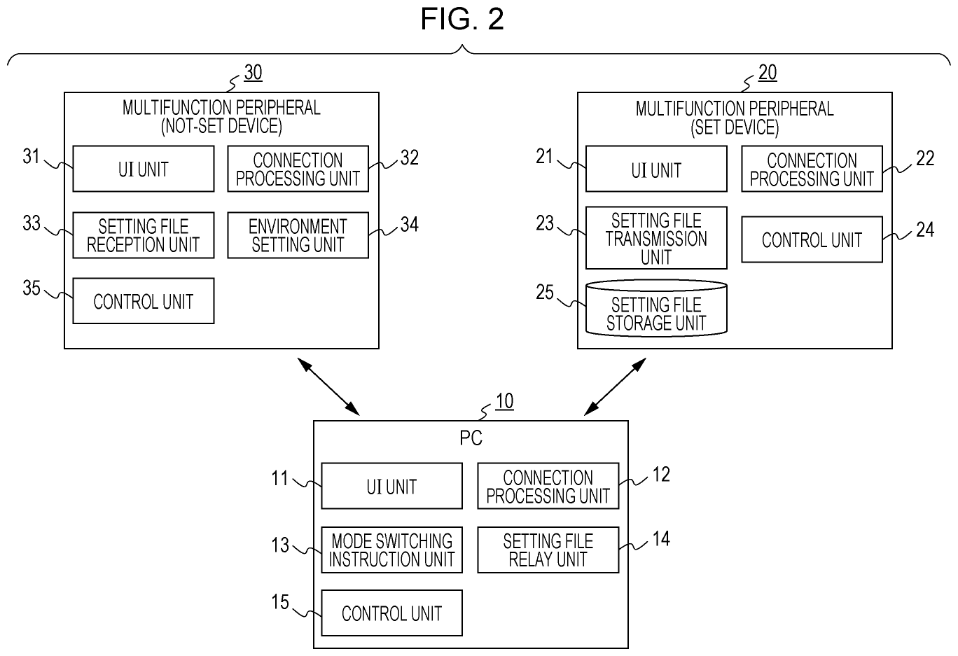

FIG. 2 is a block configuration diagram illustrating an information processing system according to the present exemplary embodiment. FIG. 2 illustrates a PC 10 and two multifunction peripherals 20 and 30. The PC 10 corresponds to the PC 41 illustrated in FIG. 1 that is used in the same on-premise environment 4 as the multifunction peripherals 20 and 30. As will be described later, since the PC 10 is used for configuring the settings for the multifunction peripheral 30 to be compatible with the zero trust environment, it is assumed that the PC 10 is used by an administrator.

The multifunction peripheral 20 corresponds to the multifunction peripheral 42 illustrated in FIG. 1. Since the settings for the multifunction peripheral 20 to be compatible with the zero trust environment have been configured, the multifunction peripheral 20 is also referred to as the “set device 20” in the following description. Since the multifunction peripheral 30 is a multifunction peripheral to be newly introduced into the on-premise environment 4, the settings for the multifunction peripheral 30 to be compatible with the zero trust environment have not yet been configured. For this reason, the multifunction peripheral 30 is also referred to as the “not-set device 30” in the following description.

In the present exemplary embodiment, environment setting equivalent to that for the set device 20 is performed for the not-set device 30 by performing so-called cloning in which the settings configured for the set device 20 are duplicated in the not-set device 30. In particular, in the present exemplary embodiment, the settings for the not-set device 30 to be compatible with the zero trust environment are configured. The not-set device 30 turns into the set device 20 when the environment setting to be compatible with the zero trust environment is completed, and is incorporated into the information processing system.

The PC 10 includes a user interface (UI) unit 11, a connection processing unit 12, a mode switching instruction unit 13, a setting file relay unit 14, and a control unit 15. Note that constituent elements not used in the description of the present exemplary embodiment are omitted from the drawings. The user interface unit 11 receives user input and performs display on a display. The connection processing unit 12 performs network connection with other devices (the multifunction peripherals 20 and 30 in the case of the present exemplary embodiment).

The information processing system according to the present exemplary embodiment is provided with, as operation modes, a “zero trust mode” as a mode during normal operation and an “environment setting mode” as a mode used when the not-set device 30 is set to be a multifunction peripheral compatible with the zero trust environment by cloning the settings of the set device 20 for the not-set device 30. Needless to say, other operation modes may be provided. The mode switching instruction unit 13 instructs the multifunction peripherals 20 and 30 to switch the mode. Note that details of each operation mode will be described later. The setting file relay unit 14 relays a setting file to be transmitted from the set device 20 to the not-set device 30. As described above, the setting file includes the contents of setting for the set device 20, in particular, information necessary for configuring the settings for the not-set device 30 to be compatible with the zero trust environment. The not-set device 30 performs environment setting by using the setting file. The control unit 15 controls the operation of the constituent elements 11 to 14 described above.

The constituent elements 11 to 15 in the PC 10 are implemented by cooperative operation of a computer installed in the PC 10 and programs running on a CPU installed in the computer.

The set device 20 includes a user interface (UI) unit 21, a connection processing unit 22, a setting file transmission unit 23, a control unit 24, and a setting file storage unit 25. Note that constituent elements not used in the description of the present exemplary embodiment are omitted from the drawings.

The user interface unit 21 is implemented by an operation panel, receives user operation on the operation panel, and performs display on the operation panel. The connection processing unit 22 performs network connection with other devices (the PC 10 in the case of the present exemplary embodiment). The above setting file to be transmitted to the not-set device 30 is stored in the setting file storage unit 25, and the setting file transmission unit 23 transmits the setting file stored in the setting file storage unit 25 to the not-set device 30 via the PC 10. The control unit 24 controls the operation of the constituent elements 21 to 23 described above.

The constituent elements 21 to 24 in the set device 20 are implemented by cooperative operation of a computer installed in the set device 20 and programs running on a CPU installed in the computer. Further, the setting file storage unit 25 is implemented by an HDD installed in the set device 20. Alternatively, a RAM or external storage means may be used via a network.

The not-set device 30 includes a user interface (UI) unit 31, a connection processing unit 32, a setting file reception unit 33, an environment setting unit 34, and a control unit 35. Note that constituent elements not used in the description of the present exemplary embodiment are omitted from the drawings.

The user interface unit 31 is implemented by an operation panel, receives user operation on the operation panel, and performs display on the operation panel. The connection processing unit 32 performs network connection with other devices (the PC 10 in the case of the present exemplary embodiment). The setting file reception unit 33 receives, via the PC 10, a setting file transmitted from the set device 20. The environment setting unit 34 performs environment setting for the not-set device 30 by performing cloning with reference to the received setting file. In particular, in the present exemplary embodiment, the not-set device 30 is turned into the set device 20 by setting the not-set device 30 to be a multifunction peripheral compatible with the zero trust environment. The control unit 35 controls the operation of the constituent elements 31 to 34 described above.

The constituent elements 31 to 35 in the not-set device 30 are implemented by cooperative operation of a computer installed in the not-set device 30 and programs running on a CPU installed in the computer.

Further, the programs used in the present exemplary embodiment can be provided not only by communication means but also by being stored in a computer-readable recording medium such as a USB memory. The programs provided from the communication means or the recording medium are installed in a computer, and various kinds of processing are implemented by the CPU of the computer sequentially executing the programs.

Operation modes of the information processing system according to the present exemplary embodiment will be described.

As described above, in the present exemplary embodiment, the zero trust mode and the environment setting mode are set. The zero trust mode corresponds to a security mode in which security is ensured. In the information processing system according to the present exemplary embodiment, the zero trust mode is the operation mode in normal operation. The zero trust mode is an operation mode in which the cloud service 3 such as SASE or EDR can be used in order to ensure security.

Devices having a network communication function such as the PCs 6 and 41 and the multifunction peripheral 42 illustrated in FIG. 1 generally include one or a plurality of network ports and perform data communication with other devices via a predetermined network port. However, in the zero trust environment in which a firewall is not used, there is a possibility of being attacked from the outside if a network port is left open. Therefore, in the zero trust mode, opening of network ports is controlled to be reduced to the minimum extent necessary. For example, only the network port used for the use of the cloud service 3 or the like is opened. In other words, network ports other than the minimum necessary network ports are controlled to be forcibly blocked. In this way, in the zero trust mode, restriction of opening of network ports is a requirement for ensuring security. Note that other requirements for ensuring security include installation of an SASE or EDR agent.

Incidentally, since the not-set device 30 is not compatible with the zero trust environment, as described above, the not-set device 30 receives a setting file from the set device 20 and environment setting is performed so as to be compatible with the zero trust environment. However, since opening of network ports is reduced to the minimum extent necessary in the zero trust mode, the not-set device 30 cannot receive the setting file. Therefore, in the present exemplary embodiment, the environment setting mode is provided. That is, in the environment setting mode, the minimum necessary network ports opened in the zero trust mode are blocked. Thus, the cloud service 3 necessary for ensuring security such as SASE can no longer be used. On the other hand, only a predetermined network port is opened so that the setting file can be received. Furthermore, data communication via the predetermined network port to be opened is limited to only the transmission and reception destinations of the setting file. That is, the PC 10 according to the present exemplary embodiment can communicate only with the multifunction peripherals 20 and 30, and the multifunction peripherals 20 and 30 according to the present exemplary embodiment can communicate only with the PC 10.

As described above, the information processing system according to the present exemplary embodiment operates in the zero trust mode during normal operation, and when environment setting is performed for the not-set device 30, operates in the environment setting mode as the setting mode in which only the network port used when environment setting is performed for the not-set device 30 is opened for operation. Further, as is clear from the above description, minimum necessary network ports are opened in the set device 20 during operation in the zero trust mode. Therefore, the set device 20 corresponds to a first information processing device including a first processor. On the other hand, since the not-set device 30 is a device for which the settings compatible with the security mode are configured, the not-set device 30 corresponds to a second information processing device including a second processor. Further, as will be described later in detail, since the PC 10 according to the present exemplary embodiment instructs the multifunction peripherals 20 and 30 to shift from the zero trust mode to the environment setting mode in response to an instruction from a user, the PC 10 corresponds to a third information processing device including a third processor.

Although the information processing system according to the present exemplary embodiment includes the PC 41 and the multifunction peripheral 42, the functions provided by the PC 41 and the multifunction peripheral 42 may be provided by a plurality of information processing devices.

Next, operation according to the present exemplary embodiment will be described.

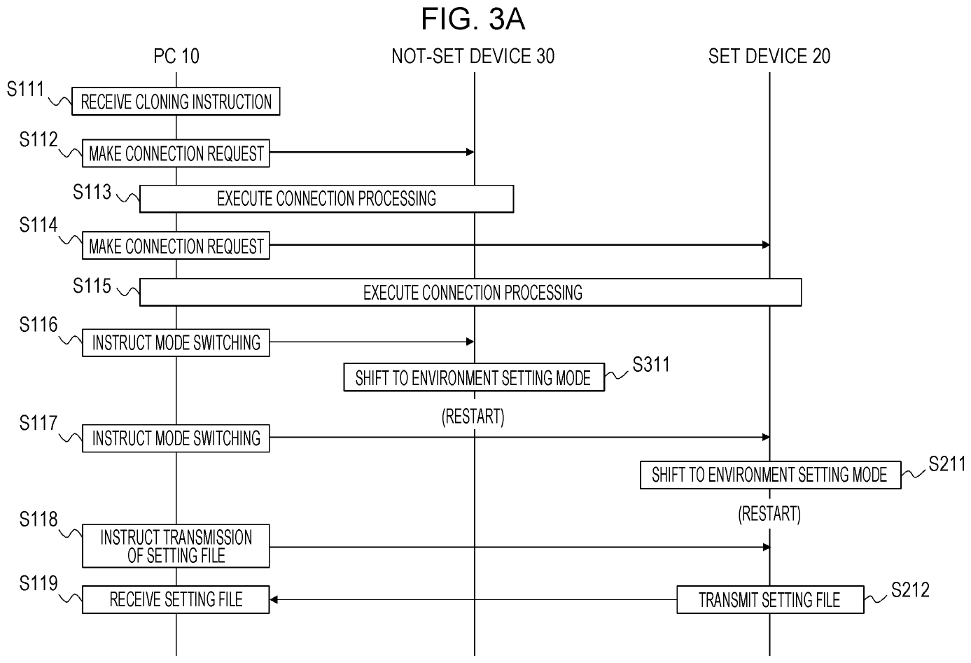

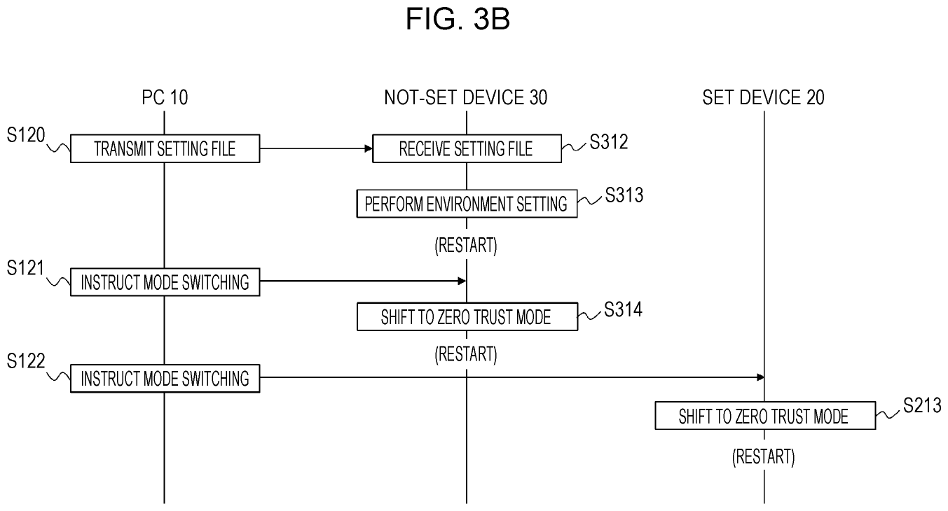

The information processing system according to the present exemplary embodiment is in a state where security is ensured during normal operation in which the information processing system is operating in the zero trust mode. In a case where the multifunction peripheral (that is, the not-set device) 30 for which the settings to be compatible with the zero trust environment are not configured is newly introduced, it is necessary to configure the settings for the not-set device 30 to be compatible with the zero trust environment. Specifically, as described above, the settings for the set device 20 are cloned for the not-set device 30. Hereinafter, processing for configuring the settings for the not-set device 30 to be compatible with the zero trust environment will be described with reference to the sequence diagrams illustrated in FIGS. 3A and 3B.

The PC 41 and the multifunction peripheral 42 (the set device 20 in FIG. 2) operate in the zero trust mode during normal operation. When the not-set device 30 is newly introduced into the on-premise environment 4, the administrator instructs cloning from the PC 10 in order to configure the settings for the not-set device 30 to be compatible with the zero trust environment. When the user interface unit 11 of the PC 10 receives a cloning instruction from the administrator (step S111), the connection processing unit 12 requests the not-set device 30 to establish a network connection (step S112). Note that the administrator may designate the not-set device 30 for which environment setting is performed by designating an IP address or the like. In response to the connection request, the connection processing unit 32 of the not-set device 30 cooperates with the connection processing unit 12 of the PC 10 and executes processing of communication line connection (step S113). In the present exemplary embodiment, the PC 10 and the not-set device 30 are connected by wireless LAN connection using WiFi Direct or short-range wireless communication line connection using BLE. Note that, if there is a LAN in the on-premise environment 4, the LAN may be used. The case of wireless LAN connection using WiFi Direct (hereinafter simply referred to as “WiFi connection”) will be described here as an example. Needless to say, connection is not limited to wireless, but may be wired. A conventional technique may be used for a method and processing of network connection.

Further, the connection processing unit 12 makes a connection request to the set device 20 in a manner similar to that in the case of the request to the not-set device 30 described above (step S114). In response to the connection request, the connection processing unit 22 of the set device 20 cooperates with the connection processing unit 12 of the PC 10 and executes processing of communication line connection (step S115).

Subsequently, the mode switching instruction unit 13 of the PC 10 instructs the not-set device 30 to switch from the zero trust mode to the environment setting mode (step S116). In response to the instruction, the control unit 35 of the not-set device 30 shifts to the environment setting mode (step S311).

Specifically, the following processing is performed as the processing of shifting to the environment setting mode in the not-set device 30. That is, the control unit 35 prohibits transmission and reception to and from devices other than the PC 10. Further, in the case of WiFi connection with the PC 10, only a predetermined network port used for reception of a setting file is opened, and other network ports are blocked. For example, in the present exemplary embodiment, only a hypertext transfer protocol (HTTP) port is opened and enabled as the predetermined network port. Note that a hypertext transfer protocol secure (HTTPS) port may be used instead of the HTTP port.

Further, the mode switching instruction unit 13 also instructs the set device 20 to switch from the zero trust mode to the environment setting mode (step S117). In response to the instruction, the control unit 24 of the set device 20 shifts to the environment setting mode (step S211). When the mode is shifted, the control unit 24 restarts the set device 20 as necessary.

Specifically, the following processing is performed as the processing of shifting to the environment setting mode in the set device 20. That is, the control unit 24 prohibits transmission and reception to and from devices other than the PC 10. Further, in the case of WiFi connection with the PC 10, only a network port used for transmission of a setting file is opened, and other network ports are blocked. In the present exemplary embodiment, only the same HTTP port as that of the not-set device 30 is opened and enabled. Further, the control unit 24 disables the agent for ensuring security such as SASE or EDR, which had been enabled during the operation in the zero trust mode. This is because the network port used for the use of the cloud service 3 is blocked.

Furthermore, the control unit 24 disables reception of a job. This is to avoid a situation in which, if an unauthorized job sent from an HTTP port opened for use by a setting file is accepted and executed, the set device 20 is destroyed by the job or information held in the set device 20 is leaked out via a network. Note that handling of a job will be described later separately.

As described above, the PC 10 instructs each of the multifunction peripherals 20 and 30 to shift to the environment setting mode with an instruction from a user as a predetermined trigger. Then, in response to the mode switching instruction (steps S116 and S117) performed with an instruction from a user as a predetermined trigger, each of the multifunction peripherals 20 and 30 shifts from the zero trust mode to the environment setting mode.

Incidentally, in the above description, a case has been exemplified in which the multifunction peripherals 20 and 30 are controlled to be automatically switched to the environment setting mode. However, a user may be inquired of in advance whether the mode is to be switched.

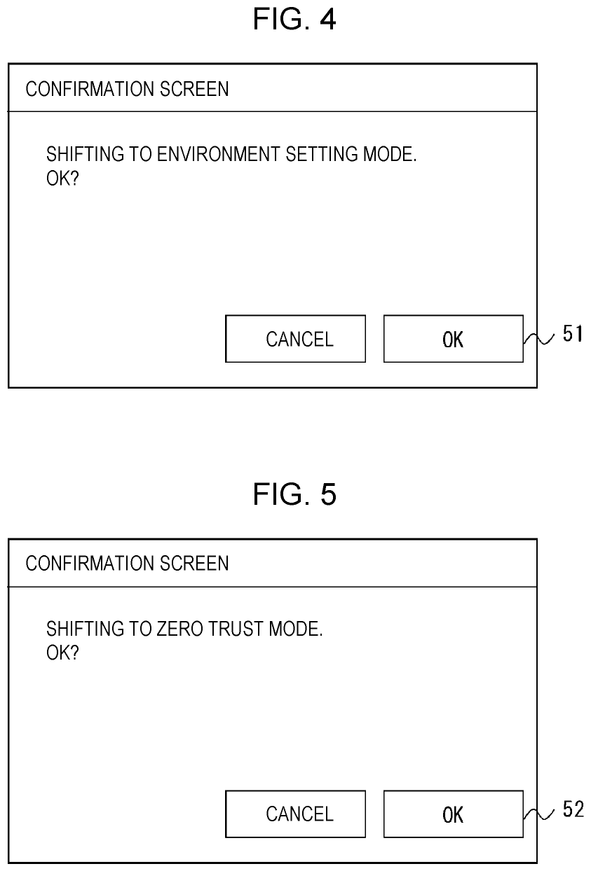

FIG. 4 is a diagram illustrating an example of a confirmation screen displayed on each of the operation panels of the multifunction peripherals 20 and 30. By cooperating with the control units 24 and 35 and displaying the confirmation screen illustrated in FIG. 4 on the operation panels, the mode switching instruction unit 13 can confirm with the administrator of each of the multifunction peripherals 20 and 30 or the user who is currently using the multifunction peripheral whether the mode is to be switched. The mode switching instruction unit 13 may instruct to switch the mode, that is, to shift to the environment setting mode, only after an OK button 51 is selected.

Through the above-described processing, the PC 10 is connected with one not-set device 30 and one set device 20, and then causes the devices to shift to the environment setting mode. Note that, in FIG. 3A, the not-set device 30 is caused to perform the processing first, but either the set device 20 or the not-set device 30 may be caused to perform the processing first.

When both of the set device 20 and the not-set device 30 shift to the environment setting mode as described above and start operating, the control unit 15 of the PC 10 instructs the set device 20 to transmit a setting file (step S118). In the present exemplary embodiment, since exchange is performed via an HTTP port in the case of WiFi connection, the control unit 15 makes an HTTP request for transmission of the setting file.

The control unit 24 of the set device 20 gives an instruction to the setting file transmission unit 23 in response to the transmission instruction from the PC 10. In response to the instruction from the control unit 24, the setting file transmission unit 23 reads the setting file from the setting file storage unit 25 and transmits the setting file to the PC 10 (step S212). In the present exemplary embodiment, since exchange is performed via an HTTP port in the case of WiFi connection, the setting file transmission unit 23 transmits the setting file as an HTTP response to the HTTP request from the PC 10.

When the setting file transmitted from the set device 20 is received (step S119), the setting file relay unit 14 of the PC 10 transmits the setting file to the not-set device 30 (step S120). In this way, the setting file relay unit 14 relays the setting file transmitted from the set device 20 to the not-set device 30.

When the setting file reception unit 33 of the not-set device 30 receives the setting file from the set device 20 via the PC 10 (step S312), the environment setting unit 34 performs environment setting by cloning the settings for the set device 20 with reference to the setting file (step S313). For example, various attributes are set so that functions equivalent to those of the set device 20 can be exercised as a multifunction peripheral, and in the case of the present exemplary embodiment, an SASE or EDR agent is installed so that security is ensured during zero trust mode operation. Thereafter, the control unit 35 restarts the not-set device 30 as necessary. Note that, even in the case of restart, the PC 10 and the not-set device 30 cooperate with each other and establish WiFi connection.

When the administrator knows that the cloning in the not-set device 30 is finished and the environment setting is finished by the not-set device 30 being restarted or the like, the administrator instructs the PC 10, by input, to switch the mode. In response to the instruction from the user, the mode switching instruction unit 13 of the PC 10 instructs the not-set device 30 to switch from the environment setting mode to the zero trust mode (step S121). In response to the instruction, the control unit 35 of the not-set device 30 shifts to the zero trust mode (step S314). When the mode is shifted, the control unit 35 restarts the not-set device 30 as necessary.

Note that the not-set device 30 turns into the set device 20 by performing environment setting. However, in order to avoid confusion with the multifunction peripheral which is originally the set device 20, description will be continued here with the not-set device 30 referred to as the “multifunction peripheral 30”.

Specifically, the following processing is performed as the processing of shifting to the environment setting mode in the multifunction peripheral 30. That is, the control unit 35 permits transmission and reception to and from devices other than the PC 10. Further, in the case of WiFi connection with the PC 10, opened HTTP ports are blocked. Minimum necessary network ports are opened for being used in communication or the like with the cloud service 3 used for ensuring security such as SASE or EDR. In other words, other network ports are blocked. In the case of BLE connection with the PC 10, BLE is disabled. In the case of WiFi connection with the PC 10, WiFi direct is disabled. The control unit 35 enables the agent for ensuring security such as SASE or EDR, which has been installed by the current environment setting.

Further, the mode switching instruction unit 13 also instructs the set device 20 to switch from the environment setting mode to the zero trust mode (step S122). In response to the instruction, the control unit 24 of the set device 20 shifts to the zero trust mode (step S213). When the mode is shifted, the control unit 24 restarts the set device 20 as necessary.

Specifically, the following processing is performed as the processing of shifting to the zero trust mode in the set device 20. That is, the control unit 24 permits transmission and reception to and from devices other than the PC 10. Further, in the case of WiFi connection with the PC 10, opened HTTP ports are blocked. Minimum necessary network ports are opened for being used in communication or the like with the cloud service 3 used for ensuring security such as SASE or EDR. In other words, other network ports are blocked. In the case of BLE connection with the PC 10, BLE is disabled. In the case of WiFi connection with the PC 10, WiFi direct is disabled. Further, the control unit 24 enables an agent for ensuring security such as SASE or EDR. Furthermore, the control unit 24 enables reception of a job. Basically, in the processing of shifting from the environment setting mode to the zero trust mode, the settings reverse to those at the time of shifting from the zero trust mode to the environment setting mode are to be configured.

Incidentally, in the above description, a case has been exemplified in which the multifunction peripherals 20 and 30 are controlled to be automatically switched to the zero trust mode. However, an inquiry may be made in advance as to whether the mode is to be switched.

FIG. 5 is a diagram illustrating an example of a confirmation screen displayed on each of the operation panels of the multifunction peripherals 20 and 30. By cooperating with the control units 24 and 35 and displaying the confirmation screen illustrated in FIG. 5 on the operation panels, the mode switching instruction unit 13 can confirm with the administrator of each of the multifunction peripherals 20 and 30 or the user who is currently using the multifunction peripheral whether the mode is to be switched. The mode switching instruction unit 13 may instruct to switch the mode, that is, to shift to the zero trust mode, only after an OK button 52 is selected.

Note that, in FIG. 3B, the multifunction peripheral 30 is caused to perform first the processing of the mode switching instruction for shifting to the zero trust mode, but either the set device 20 or the multifunction peripheral 30 may be caused to perform the processing first.

Handling of a job in the set device 20 will be described.

It has been described that, since there is a possibility that the control unit 24 of the set device 20 is affected by an unauthorized job, the control unit 24 does not accept a job during operation in the environment setting mode. However, it can be said that no problem arises even if a job is accepted as long as it can be determined whether the job is an unauthorized job, that is, as long as the job is not unauthorized. Therefore, the control unit 24 controls execution of a job received during operation in the environment setting mode according to the type of the job.

For example, a job that is to be executed during operation in the zero trust mode can be determined to be an authorized job since the job is accepted in an operating environment in which security is ensured. For example, a job may be determined to be an authorized job during operation in the zero trust mode if the job is facsimile reception print, facsimile reception transfer, email reception print, or the like which may be normally created. Therefore, any of these types of jobs may be accepted during operation in the environment setting mode. However, since the set device 20 is operating in the environment setting mode, the control unit 24 may perform control in such a manner that the execution of a received job is not immediately started but the job is temporarily accumulated and the accumulated job is executed after the set device 20 has shifted to the zero trust mode.

On the other hand, the control unit 24 determines that a job may be an unauthorized job and does not execute the job during operation in the zero trust mode if the job is a print job that is normally not created, for example, a print job such as HTTP upload print in which an ordinary multifunction peripheral serves as a server. Therefore, the control unit 24 may discard the unauthorized job. Further, after the set device 20 has shifted to the zero trust mode, the control unit 24 may notify the administrator of the reception of an unauthorized job or record the reception as a log. Further, the control unit 24 may temporarily hold an unauthorized job without executing it, and after shifting to the zero trust mode, upload the job to the cloud and execute it in an environment where safety is ensured. The execution of a job controlled by the control unit 24 described above may be determined by the control unit 24 itself, or may be processed in accordance with an instruction from the administrator.

As described above, the set device 20 and the multifunction peripheral 30 start normal operation by changing the operation mode back to the zero trust mode from the environment setting mode. In particular, the multifunction peripheral 30 turns into the set device 20 by cloning, and can start operation in the zero trust environment in which security is ensured.

Note that, although in the present exemplary embodiment a case has been described as an example in which the settings for the set device 20 are cloned for the not-set device 30, that is, all of the settings for the set device 20 are duplicated, a part of the settings for the set device 20 may be duplicated in the not-set device 30. Further, a user may be allowed to select the settings for the set device 20 to be reflected in the not-set device 30. For example, a list of items to be set may be displayed on the operation panel, and a user may be allowed to select, from the list, an item to be duplicated in the not-set device 30. Further, a part of the settings for the set device 20 may be changed before the settings are configured for the not-set device 30. For example, an SASE or EDR application installed in the set device 20 is replaced with an application of a vendor different from that of the set device 20 selected by a user.

### Second Exemplary Embodiment

In the above-described first exemplary embodiment, environment setting for the not-set device 30 is progressed under the initiative of the administrator in response to an operation instruction from the administrator. Thus, it can be said that environment setting for the not-set device 30 is steadily progressed with an instruction from the administrator as a predetermined trigger. However, the processing can be automatically progressed partially without an instruction from the administrator. Therefore, in the present exemplary embodiment, the processing for performing cloning is automatically performed partially.

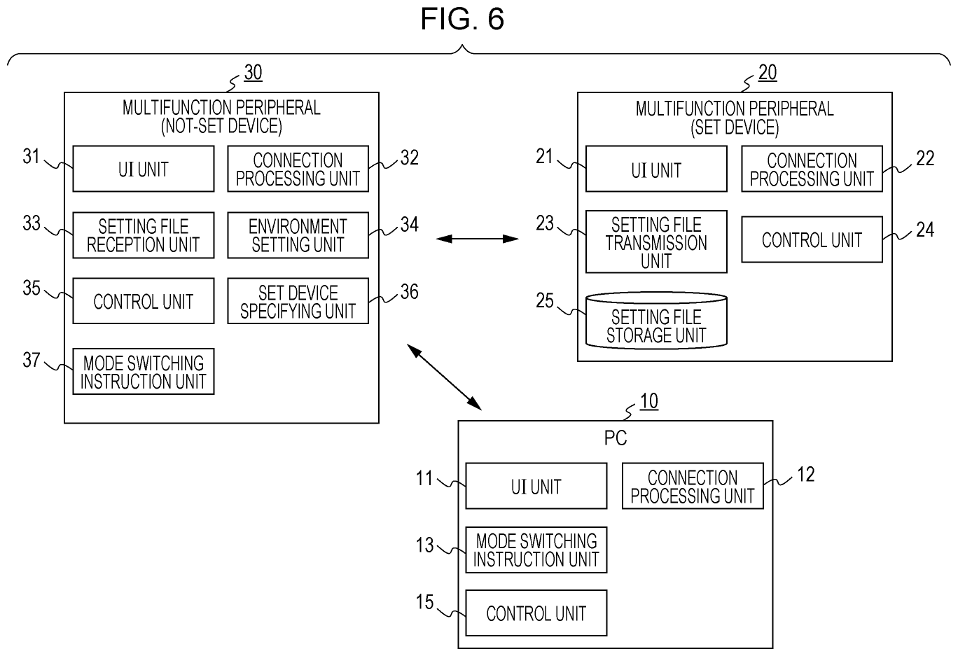

FIG. 6 is a block configuration diagram illustrating an information processing system according to the present exemplary embodiment. Note that the same constituent elements as those of the information processing system of the first exemplary embodiment illustrated in FIG. 2 are given the same reference signs, and description thereof will be omitted as appropriate. In the present exemplary embodiment, since the set device 20 directly transmits a setting file to the not-set device 30, the setting file relay unit 14 is not required in the PC 10. Further, since the not-set device 30 takes the initiative in controlling the operation of the set device 20, the not-set device 30 in the present exemplary embodiment has a configuration in which a set device specifying unit 36 and a mode switching instruction unit 37 are added to the constituent elements in the first exemplary embodiment. The set device specifying unit 36 specifies the set device 20 to be the transmission source of a setting file. The mode switching instruction unit 37 instructs the set device 20 to switch the mode.

The set device specifying unit 36 and the mode switching instruction unit 37 are implemented by cooperative operation of a computer installed in the not-set device 30 and programs running on a CPU installed in the computer.

Note that, due to the difference in constituent elements described above, the content of the operation of some constituent elements is slightly different from that in the first exemplary embodiment. The operation different from that in the first exemplary embodiment will be described together with the description of processing to be described later.

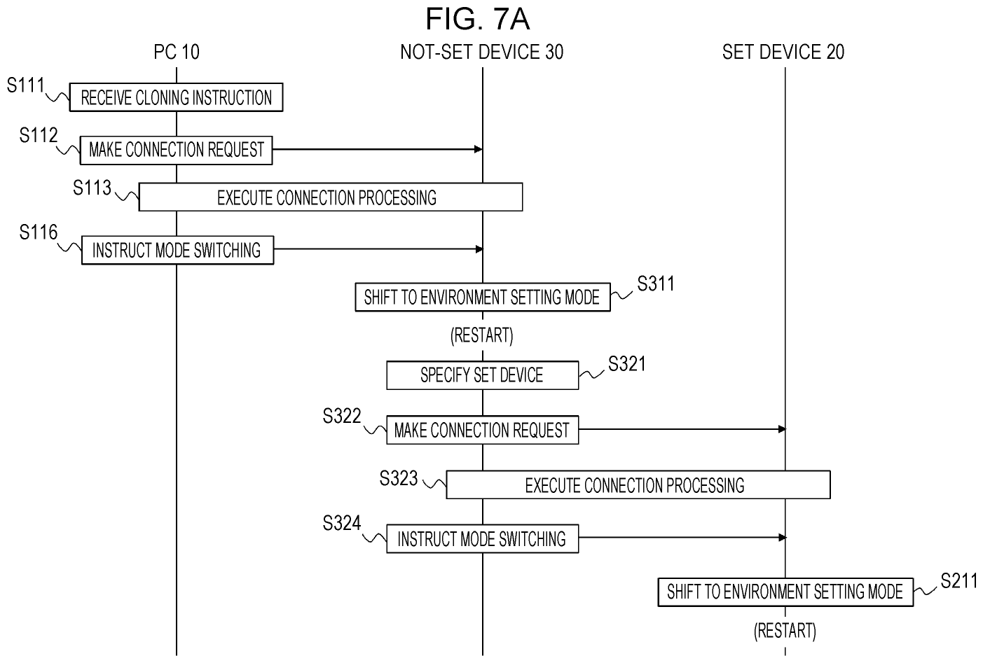

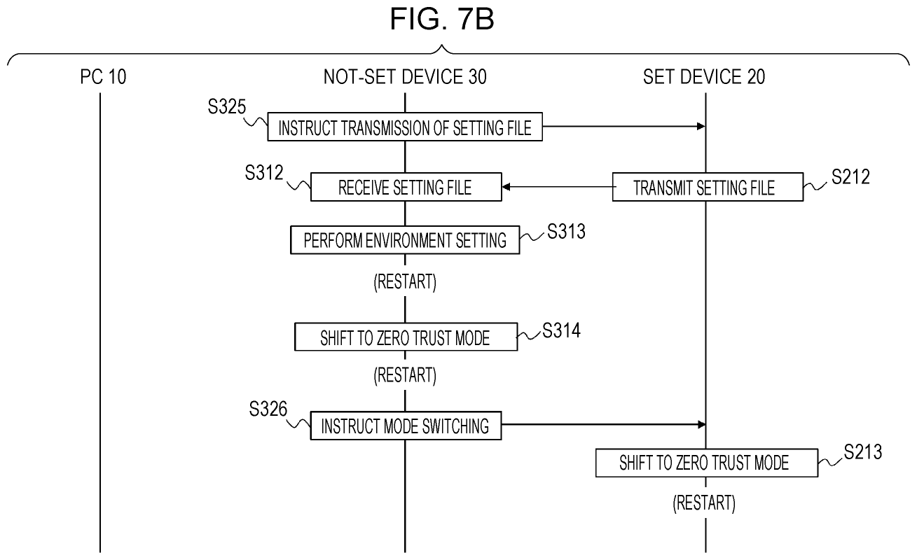

Next, processing for configuring the settings for the not-set device 30 to be compatible with the zero trust environment will be described with reference to the sequence diagrams illustrated in FIGS. 7A and 7B. FIGS. 7A and 7B are diagrams corresponding to FIGS. 3A and 3B in the first exemplary embodiment. Therefore, in FIGS. 7A and 7B, the same processing steps as those in FIGS. 3A and 3B are given the same step numbers, and description thereof will be omitted as appropriate.

First, as in the first exemplary embodiment, the PC 10 connects to the not-set device 30 in response to an operation instruction from the administrator (steps S111 to S113). On the other hand, unlike the first exemplary embodiment, the PC 10 does not perform connection processing with the set device 20.

Subsequently, the mode switching instruction unit 13 of the PC 10 instructs the not-set device 30 to switch from the zero trust mode to the environment setting mode (step S116), and the not-set device 30 shifts to the environment setting mode in response to the instruction (step S311).

Subsequently, since a plurality of multifunction peripherals 42 may exist in the on-premise environment 4, the set device specifying unit 36 specifies the set device 20 to be the transmission source of a setting file (step S321).

For example, in the case of connection with the set device 20 using BLE, the set device specifying unit 36 may specify the first-connected set device 20. Further, in the case of WiFi connection with the set device 20, the set device specifying unit 36 broadcasts and specifies, from the detected set devices 20, the set device 20 to be the transmission source of a setting file. For example, when a plurality of set devices 20 is detected, the set device specifying unit 36 may select, from the plurality of set devices 20, the first-detected set device 20 or the set device 20 having the strongest radio field intensity. Alternatively, the set device specifying unit 36 may display a list of the detected set devices 20 on the operation panel and allow a user to select a set device.

Incidentally, the multifunction peripheral detected by the not-set device 30 is not limited to the set device 20 and may be another not-set device 30. Therefore, the set device specifying unit 36 needs to determine whether the detected multifunction peripheral is the set device 20 or another not-set device 30. For example, whether specific information necessary for being compatible with the zero trust mode is held is a clear difference between the set device 20 and the not-set device 30. For example, the set device 20 holds an application such as SASE or EDR as specific information necessary for being compatible with the zero trust mode, but the not-set device 30 does not. Further, an application such as SASE or EDR is installed in the set device 20, but not in the not-set device 30. Therefore, the set device specifying unit 36 can determine whether the detected multifunction peripheral is the set device 20 or another not-set device 30 by checking whether an application such as SASE or EDR is held or installed in the detected multifunction peripheral. In this way, the set device specifying unit 36 detects the set device 20.

Alternatively, the set device specifying unit 36 may specify the set device 20 designated by the PC 10 without detecting and specifying the set device 20 by itself. In the case of WiFi connection with the set device 20, the set device specifying unit 36 acquires connection information including the IP address of the set device 20 from the PC 10. The connection information may be acquired at the time of the connection request (step S112) or the mode switching instruction (step S116), or may be acquired in another processing step.

In the present exemplary embodiment, the operation of the set device 20 is controlled under the initiative of the not-set device 30, and not under the administrator's initiative as in the first exemplary embodiment. For this reason, the connection processing unit 32 of the not-set device 30 makes a connection request to the set device 20 (step S322) and cooperates with the connection processing unit 22 of the set device 20 for communication line connection (step S323). In this way, the set device 20 in the present exemplary embodiment is directly connected to the not-set device 30 without involving the PC 10 in response to an instruction from the not-set device 30 as a predetermined trigger.

Subsequently, the mode switching instruction unit 37 of the not-set device 30 instructs the set device 20 to switch from the zero trust mode to the environment setting mode (step S324). In response to the instruction, the control unit 24 of the set device 20 shifts to the environment setting mode (step S211).

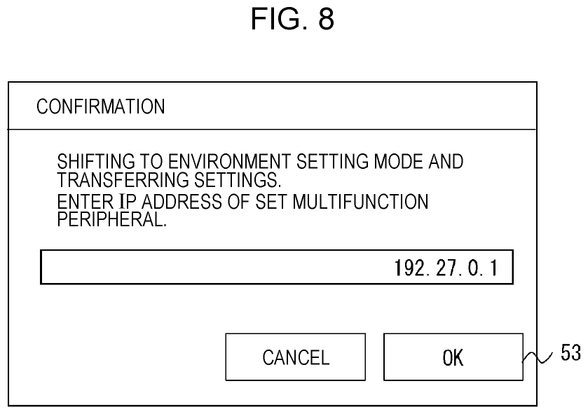

Incidentally, also in the present exemplary embodiment, an inquiry may be made in advance as to whether the mode is to be switched, as in the first exemplary embodiment. FIG. 8 is a diagram illustrating an example of a confirmation screen displayed on the operation panel of the not-set device 30. By displaying the confirmation screen illustrated in FIG. 8 on the operation panel of the not-set device 30, the mode switching instruction unit 37 can confirm with the administrator of the not-set device 30 or the user who is currently using the not-set device 30 whether the mode is to be switched. The mode switching instruction unit 37 may instruct the set device 20 to switch the mode, that is, to shift to the environment setting mode, only after an OK button 53 is selected.

Note that, although a user is asked to enter an IP address in the confirmation screen illustrated in FIG. 8, the IP address of the set device 20 that has been specified by the set device specifying unit 36 may be displayed as an initial value so as to allow confirmation with the user without inputting an IP address.

Subsequently, the control unit 35 of the not-set device 30 instructs the set device 20 specified by the set device specifying unit 36 as described above to transmit a setting file (step S325). In the first exemplary embodiment, the PC 10 instructs the set device 20 to transmit a setting file. However, in the present exemplary embodiment, the not-set device 30 instructs the set device 20 to transmit a setting file by an HTTP request. In the present exemplary embodiment, since the not-set device 30 gives an instruction to transmit a setting file, the setting file transmission unit 23 directly transmits the setting file to the not-set device 30 as an HTTP response to the HTTP request from the not-set device 30 (step S212).

Thereafter, the environment setting unit 34 performs environment setting with reference to the setting file directly received from the set device 20 (step S313), and the not-set device 30 shifts to the zero trust mode (steps S313 to S314). Thereafter, the mode switching instruction unit 37 instructs the set device 20 to switch the mode, that is, to shift to the zero trust mode (step S326).

The control unit 24 of the set device 20 shifts to the zero trust mode in response to the instruction from the not-set device 30 as a predetermined trigger (step S213).

The present exemplary embodiment is the same as the first exemplary embodiment in that an instruction from a user of the PC 10, that is, the administrator is received as a predetermined trigger to start cloning (step S111), but is different from the first exemplary embodiment in that the not-set device 30 initiatively controls the operation for the subsequent processing.

### Third Exemplary Embodiment

In the second exemplary embodiment, an instruction from the administrator is received as a predetermined trigger. In the present exemplary embodiment, the operation mode is switched and cloning is performed with the fact that the set device specifying unit 36 of the not-set device 30 has detected by itself the set device 20 to be the transmission source of a setting file, as a predetermined trigger.

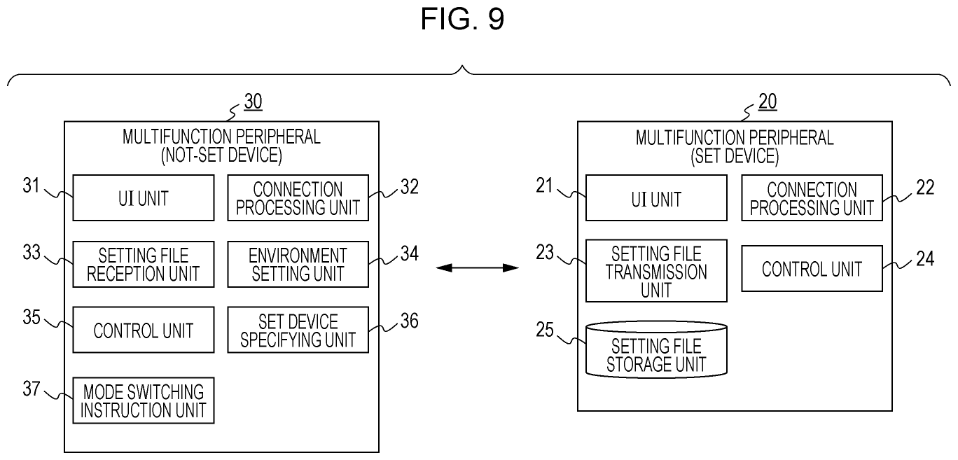

FIG. 9 is a block configuration diagram illustrating an information processing system according to the present exemplary embodiment. Note that the same constituent elements as those of the information processing system of the first exemplary embodiment illustrated in FIG. 2 are given the same reference signs, and description thereof will be omitted as appropriate. In the present exemplary embodiment, since the set device 20 directly transmits a setting file to the not-set device 30 and an instruction from the administrator is not required, the PC 10 is not required unlike the first and second exemplary embodiments. The constituent elements of the set device 20 and the not-set device 30 may be the same as those in the second exemplary embodiment. However, constituent elements of which content of operation is slightly different from that in the second exemplary embodiment will be described together with the description of processing.

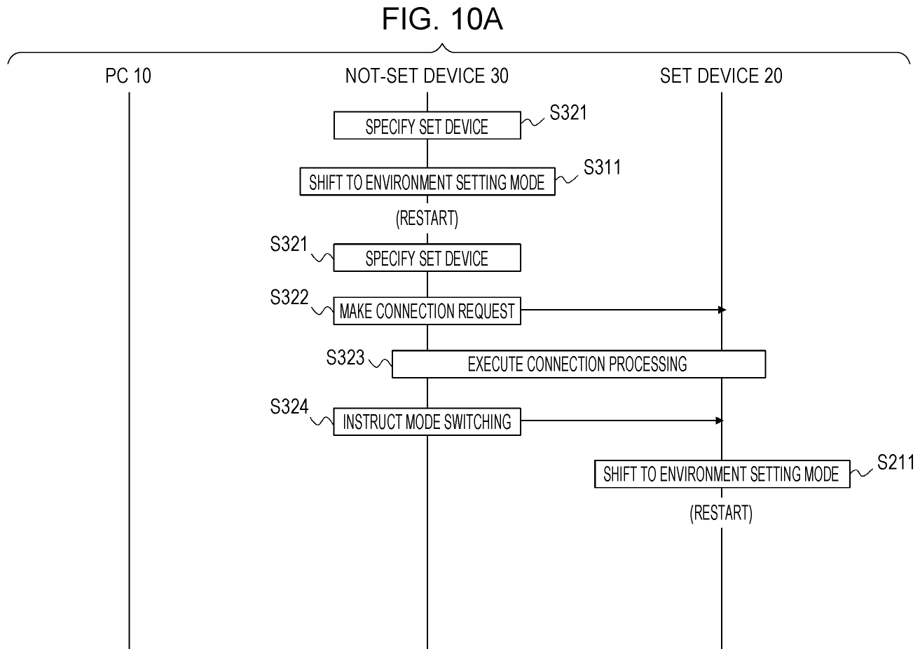

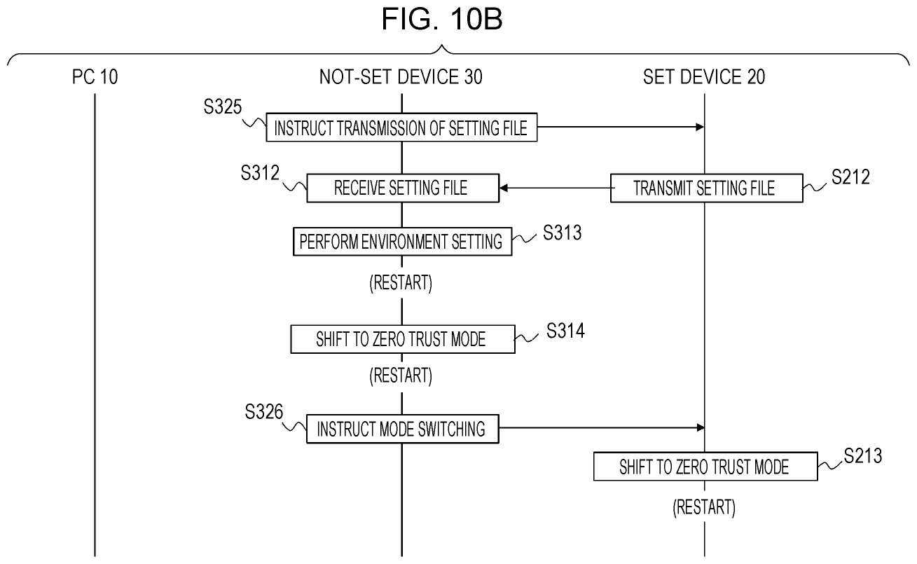

Next, processing for configuring the settings for the not-set device 30 to be compatible with the zero trust environment will be described with reference to the sequence diagrams illustrated in FIGS. 10A and 10B. FIGS. 10A and 10B are diagrams corresponding to FIGS. 3A and 3B in the first exemplary embodiment and FIGS. 7A and 7B in the second exemplary embodiment. Therefore, in FIGS. 10A and 10B, the same processing steps as those in FIGS. 3A and 3B and FIGS. 7A and 7B are given the same step numbers, and description thereof will be omitted as appropriate.

When the not-set device 30 is newly installed in the on-premise environment 4 and powered on, the set device specifying unit 36 specifies, with this being a predetermined trigger, the set device 20 to be the transmission source of a setting file (step S321). In the present exemplary embodiment, the not-set device 30 is connected by wireless LAN connection using WiFi Direct or short-range wireless communication line connection using BLE, as in the second exemplary embodiment.

Further, if a LAN is used in the on-premise environment 4, the LAN may be used.

In the present exemplary embodiment, as described above, cloning to be described later is started with the fact that the set device specifying unit 36 has specified the set device 20 as a predetermined trigger. Since the subsequent processing steps performed in the set device 20 and the not-set device 30 may be the same as those in the second exemplary embodiment, description thereof will be omitted.

### Fourth Exemplary Embodiment

In the above-described first and second exemplary embodiments, the administrator uses the PC 10 and gives an instruction to the not-set device 30 as the predetermined trigger for starting cloning. In the present exemplary embodiment, the predetermined trigger is a case where the administrator gives an instruction to the set device 20.

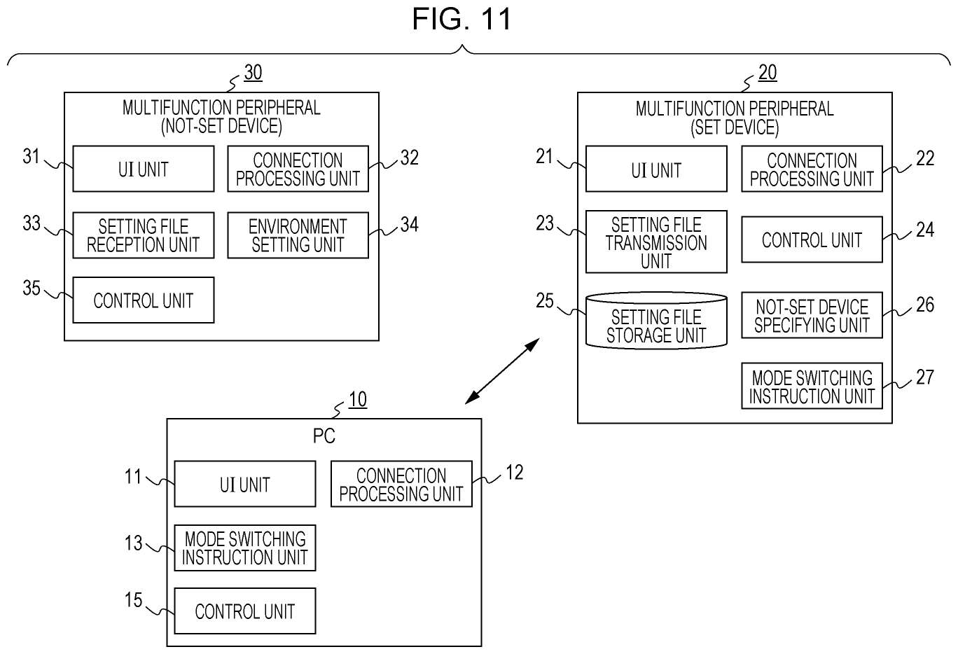

FIG. 11 is a block configuration diagram illustrating an information processing system according to the present exemplary embodiment. Note that the same constituent elements as those of the information processing system of the first exemplary embodiment illustrated in FIG. 2 are given the same reference signs, and description thereof will be omitted as appropriate. In the present exemplary embodiment, since the set device 20 directly transmits a setting file to the not-set device 30, the setting file relay unit 14 of the PC 10 is not required. Further, since the set device 20 initiatively controls the operation of the not-set device 30, the set device 20 in the present exemplary embodiment has a configuration in which a not-set device specifying unit 26 and a mode switching instruction unit 27 are added to the constituent elements in the first exemplary embodiment. The not-set device specifying unit 26 specifies the not-set device 30 to be the transmission destination of a setting file. The mode switching instruction unit 27 instructs the not-set device 30 to switch the mode.

The not-set device specifying unit 26 and the mode switching instruction unit 27 are implemented by cooperative operation of a computer installed in the set device 20 and programs running on a CPU installed in the computer.

Note that, due to the difference in constituent elements described above, the content of the operation of some constituent elements is slightly different from that in the first exemplary embodiment. Such difference in operation will be described together with the description of processing to be described later.

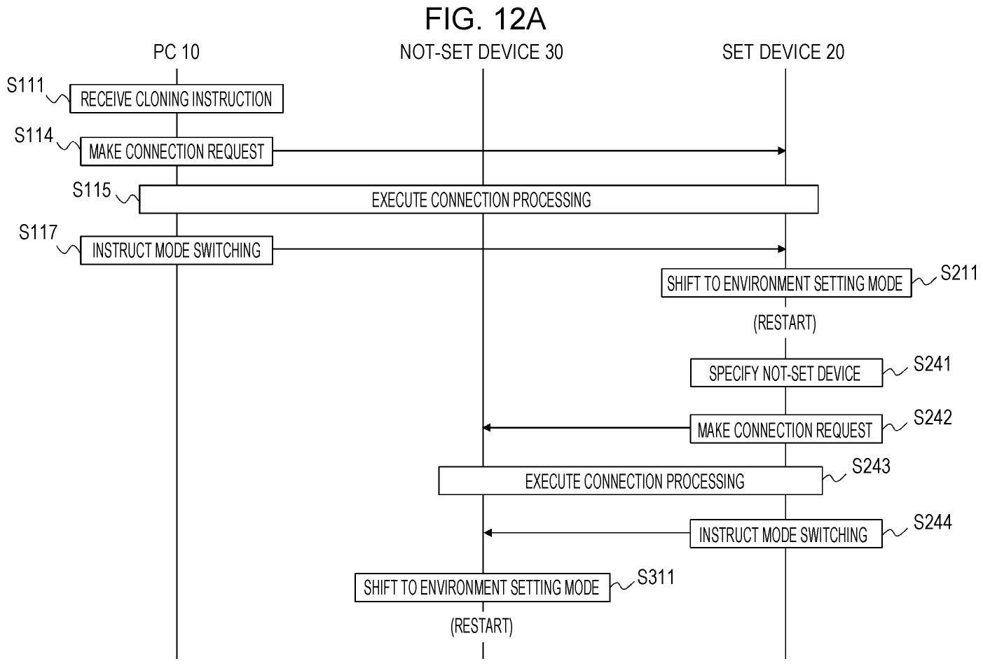

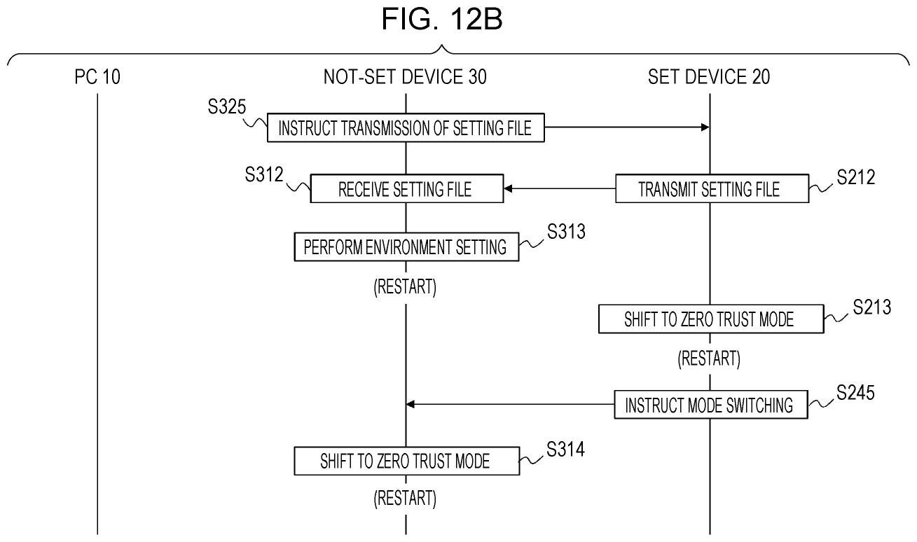

Next, processing for configuring the settings for the not-set device 30 to be compatible with the zero trust environment will be described with reference to the sequence diagrams illustrated in FIGS. 12A and 12B. FIGS. 12A and 12B are diagrams corresponding to FIGS. 3A and 3B in the first exemplary embodiment. Therefore, in FIGS. 12A and 12B, the same processing steps as those in FIGS. 3A and 3B are given the same step numbers, and description thereof will be omitted as appropriate.

When the user interface unit 11 of the PC 10 receives a cloning instruction from the administrator (step S111), the connection processing unit 12 in the present exemplary embodiment requests the set device 20 to establish a network connection (step S114), and cooperates with the connection processing unit 22 of the set device 20 and executes processing of communication line connection (step S115).

Subsequently, when the PC 10 connects to the set device 20 in response to an instruction from the user, the mode switching instruction unit 13 instructs the set device 20 to switch from the zero trust mode to the environment setting mode (step S117). In response to the instruction, the control unit 24 of the set device 20 shifts to the environment setting mode (step S211). In this way, the set device 20 in the present exemplary embodiment shifts to the environment setting mode with an instruction from a user as a predetermined trigger.

As is clear from the above description, the PC 10 in the present exemplary embodiment does not perform any control for the not-set device 30, and as will be described later, the set device 20 takes the initiative in controlling the operation of the not-set device 30.

Subsequently, the not-set device specifying unit 26 specifies the not-set device 30 to be the transmission destination of a setting file (step S241). The performed processing is equivalent to the processing in the second exemplary embodiment (step S321) in which the set device specifying unit 36 of the not-set device 30 specifies the set device 20 to be the transmission source of a setting file. As is the case with the set device specifying unit 36, there are cases in which the not-set device specifying unit 26 detects not only the not-set device 30 but also another set device 20. In such cases, the not-set device specifying unit 26 makes a determination similar to that made by the set device specifying unit 36. That is, the not-set device specifying unit 26 determines that the detected multifunction peripheral is the not-set device 30 when the multifunction peripheral does not hold specific information necessary for being compatible with the zero trust mode.

Incidentally, while the not-set device 30 is required to specify one set device 20 as the transmission source of a setting file, the set device 20 may specify a plurality of not-set devices 30 as the transmission destinations of a setting file.

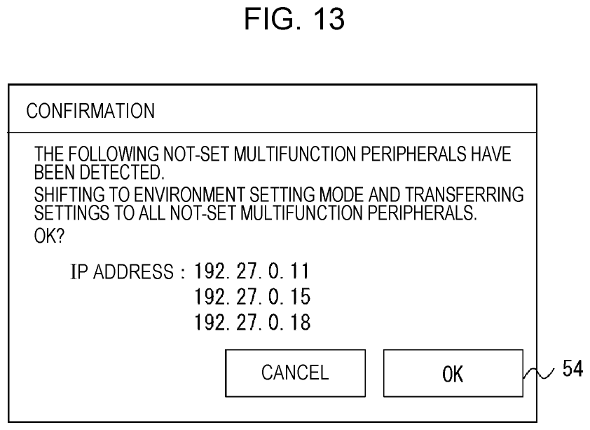

Incidentally, also in the present exemplary embodiment, an inquiry may be made in advance as to whether the mode is to be switched, as in the above-described exemplary embodiment. FIG. 13 is a diagram illustrating an example of a confirmation screen displayed on the operation panel of the set device 20. By displaying the confirmation screen illustrated in FIG. 13 on the operation panel, the mode switching instruction unit 27 can confirm with the administrator of the set device 20 or the user who is currently using the set device 20 whether the mode is to be switched. The mode switching instruction unit 27 may instruct the not-set device 30 to switch the mode, that is, to shift to the environment setting mode, only after an OK button 54 is selected.

Incidentally, FIG. 13 is an example of display for a case in which a plurality of not-set devices 30 is detected by the not-set device specifying unit 26 for performing environment setting, and is an example in which the IP addresses of the detected plurality of not-set devices 30 are simply displayed in a list. However, instead of an IP address, a device name or the like may be displayed as the identification information of the not-set device 30. Further, check boxes may be displayed in association with the IP addresses so that a user can select one or a plurality of not-set devices 30 for which environment setting is performed.

Further, as is the case with the set device specifying unit 36 in the second exemplary embodiment, the not-set device specifying unit 26 may specify the not-set device 30 designated by the PC 10 without detecting and specifying the not-set device 30 by itself.

When the not-set device 30 is specified, the connection processing unit 22 subsequently makes a connection request to the not-set device 30 (step S242) and cooperates with the connection processing unit 32 of the not-set device 30 for communication line connection (step S243). In this way, the not-set device 30 in the present exemplary embodiment is directly connected to the set device 20 without involving the PC 10 in response to an instruction from the set device 20 as a predetermined trigger.

Subsequently, the mode switching instruction unit 27 of the set device 20 instructs the not-set device 30 to switch from the zero trust mode to the environment setting mode (step S244). In response to the instruction from the set device 20, the control unit 35 of the not-set device 30 shifts to the environment setting mode (step S311).

When the set device 20 and the not-set device 30 are connected as described above, the control unit 35 of the not-set device 30 instructs the set device 20 to transmit a setting file (step S325). In response to the instruction, the setting file transmission unit 23 directly transmits the setting file to the not-set device 30.

When the setting file reception unit 33 receives the setting file from the set device 20 (step S312), the environment setting unit 34 performs environment setting with reference to the setting file (step S313).

After transmission of the setting file, the control unit 24 of the set device 20 causes the set device 20 to shift to the zero trust mode (step S213). Further, when it is detected that the not-set device 30 has been restarted, the mode switching instruction unit 27 instructs the not-set device 30 to switch from the environment setting mode to the zero trust mode (step S245). In response to the instruction, the control unit 35 of the not-set device 30 shifts to the zero trust mode (step S314).

According to the present exemplary embodiment, environment setting can be performed for the not-set device 30 under the initiative of the set device 20. In a case where the set device 20 performs environment setting for a plurality of not-set devices 30, the processing of steps S242 to S245 is to be repeatedly performed for each not-set device 30. That is, the set device 20 directly transmits a setting file to each of the plurality of not-set devices 30. In the case where a plurality of not-set devices 30 is to be processed, the plurality of not-set devices 30 may be processed one by one in order, or may be processed simultaneously in parallel according to the progress of processing in each not-set device 30, such as completion of connection, completion of shifting to the environment setting mode, or the like.

Note that, in the third exemplary embodiment, a case has been described in which cloning is started with the case where the set device specifying unit 36 of the not-set device 30 detects by itself the set device 20 to be the transmission source of a setting file, as a predetermined trigger. Similarly, in the case where the set device 20 initiatively controls cloning, cloning may be started not with an instruction from a user, but with the case where the not-set device specifying unit 26 detects by itself the not-set device 30 to be the transmission destination of a setting file, as a predetermined trigger.

In the above-described exemplary embodiment, a processor refers to a processor in a broad sense, and includes general-purpose processors (for example, a central processing unit (CPU) and the like) and dedicated processors (for example, a graphics processing unit (GPU), an application specific integrated circuit (ASIC), a field programmable gate array (FPGA), a programmable logic devices, and the like).

Further, the operation of a processor in the above-described exemplary embodiment may be performed not only by one processor but also by a plurality of processors existing at physically distant positions in cooperation with each other. Further, the order of the operations of a processor is not limited to the order described in the above-described exemplary embodiments, and may be changed as appropriate.

### APPENDIX

(((1)))

An information processing system comprising:
a first information processing device that includes
   a first processor, and
   one or a plurality of network ports whose opening is restricted during operation in a security mode in which security is ensured, wherein
when settings to be compatible with the security mode are configured for a second information processing device that includes a second processor and one or a plurality of network ports, the first processor and the second processor are configured to:
   cause, in response to a predetermined trigger, the first information processing device and the second information processing device to shift from the security mode to a setting mode in which only the network port used in configuring the settings for the second information processing device is opened for operation;
   duplicate the settings in the first information processing device to the second information processing device via the opened network port after the first information processing device and the second information processing device shift to the setting mode; and
   cause, in response to completion of duplication of the settings, the first information processing device and the second information device to return to the security mode from the setting mode.
      (((2)))

The information processing system according to (((1))), further comprising:
a third information processing device that includes a third processor, wherein
the third processor is configured to give, to the first processor and the second processor, an instruction to shift to the setting mode as the predetermined trigger, in response to an instruction from a user.
   (((3)))

The information processing system according to (((2))), wherein when the settings are duplicated, the third processor is configured to relay information used for the settings transmitted from the first information processing device to the second information processing device.

(((4)))

The information processing system according to (((1))), wherein
the second processor is configured to:
   in response to the predetermined trigger, causes the second information processing device to shift to the setting mode and directly connects to the first information processing device; and
   directly receives information used for the settings from the first information processing device, and
the first processor is configured to:
   in response to an instruction from the second processor as the predetermined trigger, cause the first information processing device to shift to the setting mode.
      (((5)))

The information processing system according to (((4))), wherein the second processor is configured to receive an instruction from a user as the predetermined trigger.

(((6)))

The information processing system according to (((4))), wherein the second processor is configured to regard, as the predetermined trigger, detection by itself of the first information processing device to be a duplication source of the settings.

(((7)))

The information processing system according to (((6))), wherein the second processor is configured to determine that, when another information processing device that has been detected and directly connected holds specific information necessary for being compatible with the security mode, the other information processing device is the first information processing device.

(((8)))

The information processing system according to (((1))), wherein
the first processor is configured to:
   in response to the predetermined trigger, cause the first information processing device to shift to the setting mode and directly connects to the second information processing device to be a duplication destination of the settings; and
   directly transmits information used for the settings to the connected second information processing device, and
the second processor is configured to:
   in response to an instruction from the first processor as the predetermined trigger, cause the second information processing device to shift to the setting mode.
      (((9)))

The information processing system according to (((8))), wherein the first processor is configured to receive an instruction from a user as the predetermined trigger.

(((10)))

The information processing system according to (((8))), wherein the first processor is configured to regard, as the predetermined trigger, detection by itself of the second information processing device to be a duplication destination of the settings.

(((11)))

The information processing system according to (((10))), wherein when a plurality of the second information processing devices to be duplication destinations of the settings are detected, the first processor is configured to directly transmit the information used for the settings to each of the plurality of detected second information processing devices.

(((12)))

The information processing system according to (((8))), wherein the first processor is configured to determine that, when another information processing device that has been detected and directly connected does not hold specific information necessary for being compatible with the security mode, the other information processing device is the second information processing device.

(((13)))

The information processing system according to any one of (((1))) to (((12))), wherein the first processor is configured to control execution of a job received when the first information processing device is operating in the setting mode, according to a type of the job.

(((14)))

The information processing system according to (((13))), wherein the first processor is configured to:
in a case where the type of the job is a job to be executed when the first information processing device is operating in the security mode, accumulate the job; and
execute the accumulated job after the first information processing device shifts to the security mode.
   (((15)))

The information processing system according to (((13))), wherein in a case where the type of the job is a job to be not executed when the first information processing device is operating in the security mode, the first processor is configured not to execute the job or notifies an administrator of reception of the job.

(((16)))

A program causing a first computer and a second computer to execute a process, the first computer including one or a plurality of network ports whose opening is restricted during operation in a security mode in which security is ensured, the second computer including one or a plurality of network ports and being a target for which settings to be compatible with the security mode are configured, the process comprising:
causing, in response to a predetermined trigger, the first computer and the second computer to shift from the security mode to a setting mode in which only the network port used in configuring the settings for the second computer is opened;
duplicating the settings in the first computer to the second computer via the opened network port after the first computer and the second computer shift to the setting mode; and
causing, in response to completion of duplication of the settings, the first computer and the second computer to return to the security mode from the setting mode.

What is claimed is:

1. An information processing system comprising:
a first information processing device that includes
a first processor, and
one or a plurality of network ports whose opening is restricted during operation in a security mode in which security is ensured, wherein
when settings to be compatible with the security mode are configured for a second information processing device that includes a second processor and one or a plurality of network ports, the first processor and the second processor are configured to:
cause, in response to a predetermined trigger, the first information processing device and the second information processing device to shift from the security mode to a setting mode in which only the network port used in configuring the settings for the second information processing device is opened for operation;
duplicate the settings in the first information processing device to the second information processing device via the opened network port after the first information processing device and the second information processing device shift to the setting mode; and
cause, in response to completion of duplication of the settings, the first information processing device and the second information device to return to the security mode from the setting mode.

2. The information processing system according to claim 1, further comprising:
a third information processing device that includes a third processor, wherein
the third processor is configured to give, to the first processor and the second processor, an instruction to shift to the setting mode as the predetermined trigger, in response to an instruction from a user.

3. The information processing system according to claim 2, wherein when the settings are duplicated, the third processor is configured to relay information used for the settings transmitted from the first information processing device to the second information processing device.

4. The information processing system according to claim 1, wherein
the second processor is configured to:
in response to the predetermined trigger, cause the second information processing device to shift to the setting mode and directly connects to the first information processing device; and
directly receives information used for the settings from the first information processing device, and
the first processor is configured to:
in response to an instruction from the second processor as the predetermined trigger, cause the first information processing device to shift to the setting mode.

5. The information processing system according to claim 4, wherein the second processor is configured to receive an instruction from a user as the predetermined trigger.

6. The information processing system according to claim 4, wherein the second processor is configured to regard, as the predetermined trigger, detection by itself of the first information processing device to be a duplication source of the settings.

7. The information processing system according to claim 6, wherein the second processor is configured to determine that, when another information processing device that has been detected and directly connected holds specific information necessary for being compatible with the security mode, the other information processing device is the first information processing device.

8. The information processing system according to claim 1, wherein
the first processor is configured to:
in response to the predetermined trigger, cause the first information processing device to shift to the setting mode and directly connects to the second information processing device to be a duplication destination of the settings; and
directly transmit information used for the settings to the connected second information processing device, and
the second processor is configured to:
in response to an instruction from the first processor as the predetermined trigger, cause the second information processing device to shift to the setting mode.

9. The information processing system according to claim 8, wherein the first processor is configured to receive an instruction from a user as the predetermined trigger.

10. The information processing system according to claim 8, wherein the first processor is configured to regard, as the predetermined trigger, detection by itself of the second information processing device to be a duplication destination of the settings.

11. The information processing system according to claim 10, wherein when a plurality of the second information processing devices to be duplication destinations of the settings are detected, the first processor is configured to directly transmit the information used for the settings to each of the plurality of detected second information processing devices.

12. The information processing system according to claim 8, wherein the first processor is configured to determine that, when another information processing device that has been detected and directly connected does not hold specific information necessary for being compatible with the security mode, the other information processing device is the second information processing device.

13. The information processing system according to claim 1, wherein the first processor is configured to control execution of a job received when the first information processing device is operating in the setting mode, according to a type of the job.

14. The information processing system according to claim 13, wherein the first processor is configured to:
in a case where the type of the job is a job to be executed when the first information processing device is operating in the security mode, accumulate the job; and
executes the accumulated job after the first information processing device shifts to the security mode.

15. The information processing system according to claim 13, wherein in a case where the type of the job is a job to be not executed when the first information processing device is operating in the security mode, the first processor is configured not to execute the job or notifies an administrator of reception of the job.

16. A non-transitory computer readable medium storing a program causing a first computer and a second computer to execute a process, the first computer including one or a plurality of network ports whose opening is restricted during operation in a security mode in which security is ensured, the second computer including one or a plurality of network ports and being a target for which settings to be compatible with the security mode are configured, the process comprising:
causing, in response to a predetermined trigger, the first computer and the second computer to shift from the security mode to a setting mode in which only the network port used in configuring the settings for the second computer is opened;
duplicating the settings in the first computer to the second computer via the opened network port after the first computer and the second computer shift to the setting mode; and
causing, in response to completion of duplication of the settings, the first computer and the second computer to return to the security mode from the setting mode.
